(19) United States
(12) Patent Application Publication
(10) Pub. No.: US 2025/0328110 A1
(43) Pub. Date: Oct. 23, 2025

(54) ITEM WITH A PLIQUE-À-JOUR ENAMEL DECORATION AND METHOD FOR MANUFACTURING SAME

(71) Applicant: Comadur SA, Le Locle (CH)

(72) Inventor: Johan ROMAND, Mamirolle (FR)

(73) Assignee: Comadur SA, Le Locle (CH)

(21) Appl. No.: 19/068,682

(22) Filed: Mar. 3, 2025

(30) Foreign Application Priority Data
Apr. 23, 2024 (EP) 24171989.7

(51) Int. Cl. G04B 45/00; G04B 37/22

(52) U.S. Cl. CPC G04B 45/0076; G04B 37/225; G04B 45/0084

(57) ABSTRACT

A method for manufacturing an item (1) including a through-decoration (2) filled with an enamel (3) to form a plique-à-jour enamel. The method includes: obtaining a blank (5) defined with an upper face (5a) and a lower face (5b) opposite the upper face (5a); removing part of the blank (5) from the upper face (5a) to produce a decoration (2a) that does not pass through to the lower face (5b) or, alternatively, in the previous step, obtaining said blank (5) directly with the non-through decoration (2a); depositing one or more layers of enamel (3) within the non-through decoration (2a) and firing the enamel (3) after each 10 layer has been deposited; machining, preferably by grinding, the lower face (5b) to reveal the enamel (3) and thus produce the item (1) with the through-decoration (2) filled with enamel (3).

### CROSS REFERENCE TO RELATED APPLICATIONS

This application is claiming priority based on European Patent Application No. 24171989.7 filed on Apr. 23, 2024.

### TECHNICAL FIELD OF THE INVENTION

The invention relates to a method for manufacturing an item with a plique-à-jour enamel decoration. The method according to the invention makes it possible to produce large series at a reduced cost. The invention further relates to the item produced by this method.

### TECHNOLOGICAL BACKGROUND

Plique-à-jour is a technique for applying enamel to a substrate that has no bottom at the level of the enamel. The lack of any bottom allows light to filter through the transparent or translucent enamel. The result is a miniature stained glass effect.

The conventional plique-à-jour technique consists of creating welded partitions with a metal that remains stable when the enamel is fired. During the successive firings of the layers deposited one by one, the metal partitions, mainly made of yellow or white gold for their properties, can deform or even separate from the substrate, which greatly limits the number of kiln passages and the designs that can be produced.

Moreover, a substrate is required during deposition and firing to ensure that the enamel does not run beyond the partition. As the substrates are made of quartz, it is very difficult to carry out this operation on non-planar shapes. Conventional enamel is deposited by hand, with a brush or an oiler. The layers deposited using these means are very thin, requiring dozens of layers to be deposited to achieve a total thickness that is typically less than 0.5 mm. Because of its thinness, the enamel obtained is quite fragile.

As this technique is tedious and not very reproducible, timepieces with a plique-à-jour dial are unique pieces or are produced in ultra-limited series at an exorbitant cost. To date, the lack of repeatability of this technique prevents watch manufacturers from mass-producing timepieces.

### SUMMARY OF THE INVENTION

The aim of the present invention is to overcome the above-mentioned drawbacks by proposing a manufacturing method that makes it possible to produce pieces with a plique-à-jour enamel decoration in large series at a low cost and with increased enamel strength.

To this end, the invention relates to a method for manufacturing an item comprising a through-decoration filled with an enamel to form a so-called plique-à-jour enamel, the method comprising the steps of:
Obtaining a blank defined with an upper face and a lower face opposite the upper face;
Removing part of the blank from the upper face to produce a decoration that does not pass through to the lower face or, alternatively, in the previous step, obtaining said blank directly with the non-through decoration;
Depositing one or more layers of enamel within the non-through decoration and firing the enamel after each layer has been deposited;
Machining, preferably by grinding, the lower face to reveal the enamel and thus produce the item with the through-decoration filled with enamel.

Preferably, the through-decoration is then polished.

This method is highly reproducible, allowing large production volumes to be achieved at very low cost. Complex shapes are only limited by the resistance of the substrate materials during firing or impacts.

This method allows thick layers of enamel to be deposited, making it possible to obtain an enamel with a total thickness greater than or equal to 0.5 mm with a limited number of layers, typically less than 10. This greater thickness of the enamel compared with that of enamels in the prior art means that it is less brittle and can thus be used to make external components, such as bezels, which are subject to significant stress.

More typically, the use of enamel rather than lacquer provides excellent chemical and mechanical resistance, unlike standard lacquered bezels. Enamel is also one of the materials considered to be noble in watchmaking and jewellery, unlike lacquer.

The invention is also based on the ability to grind the substrate and the enamel at the same time, while guaranteeing an optimum surface finish on both materials. Polishing the enamel also means that the part does not have to be reheated in the kiln to give it its final shiny, translucent appearance.

The transparent enamel decoration will create a depth that is impossible to achieve today. Inclined machining can also be carried out to create a translucent-opaque gradation. A colour gradation can also be deposited, for example, by spraying. Finishes can also be easily combined on the substrate, such as satin-finishing or laser texturing.

### BRIEF DESCRIPTION OF THE FIGURES

FIGS. 1a to 1e show the 5 steps of the method according to the invention. In each figure, a diagrammatic cross-sectional view of part of the item or blank and a three-dimensional view of part of the item or blank are shown.

### DETAILED DESCRIPTION OF THE INVENTION

The invention relates to a method for manufacturing an item with a plique-à-jour enamel decoration. The item can, for example, be a timepiece component. More specifically, it can be an external component chosen from the non-exhaustive list that includes a middle, a back, a bezel, a crown, a push-piece, a bracelet link, a bracelet, a tongue buckle, a clasp, a dial and a hand. The method is particularly well suited to the manufacture of items subject to high stresses, such as an external component. It may also consist of a component of the movement such as an oscillating weight. Hereafter, the invention will be more specifically described for an oscillating weight.

The manufacturing method is suitable for any substrate with a melting point higher than that of the enamel firing temperature, which is typically between 650° C. and 1100° C. depending on the composition of the enamel. The method is particularly well suited to a substrate made of a hard material such as ceramic, for example silicon nitride, zirconium oxide or aluminium oxide, or such as a sapphire or like a cermet. Some ceramics, particularly ZrO₂, have excellent mechanical-chemical adhesion with enamel, and their coefficients of expansion are very close, which causes the openwork item to retain excellent mechanical strength. These materials withstand firing cycles of up to 1000° C. for high-fire enamels, for example, and resist thermal shock for rapid firing cycles.

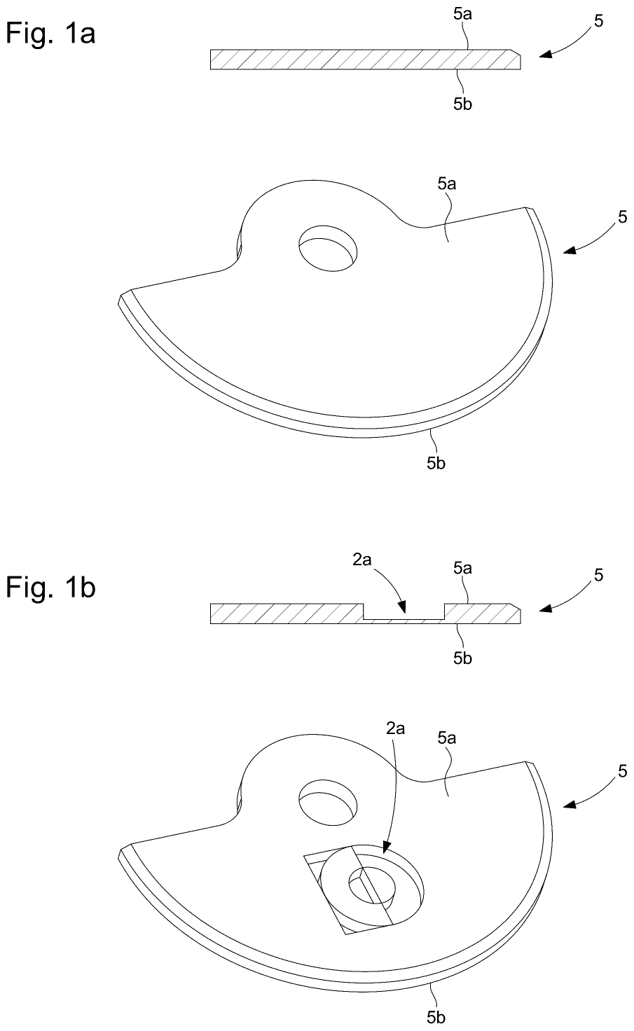

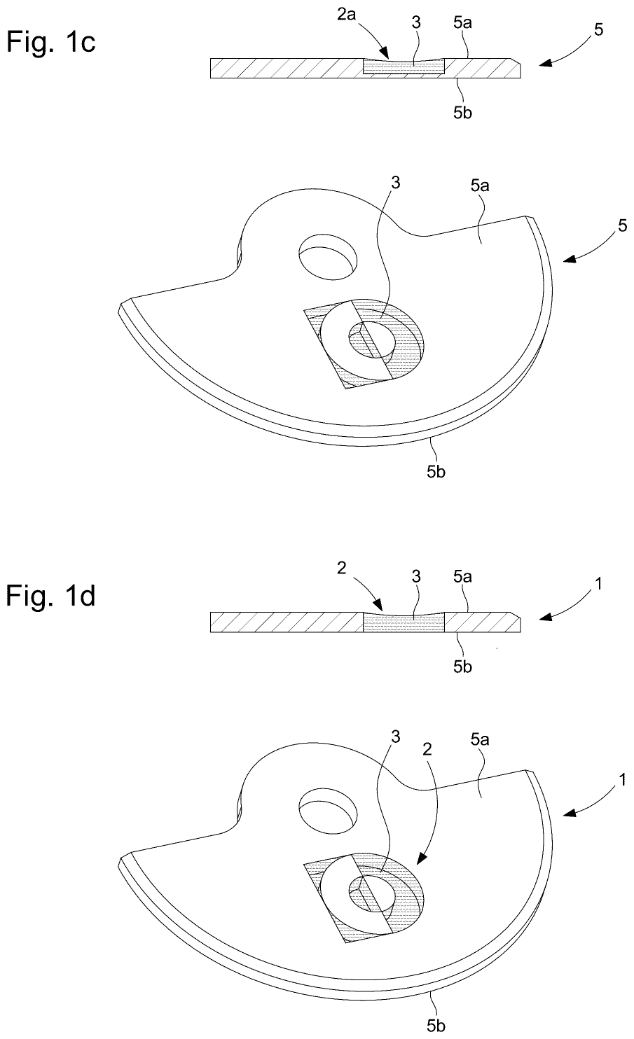

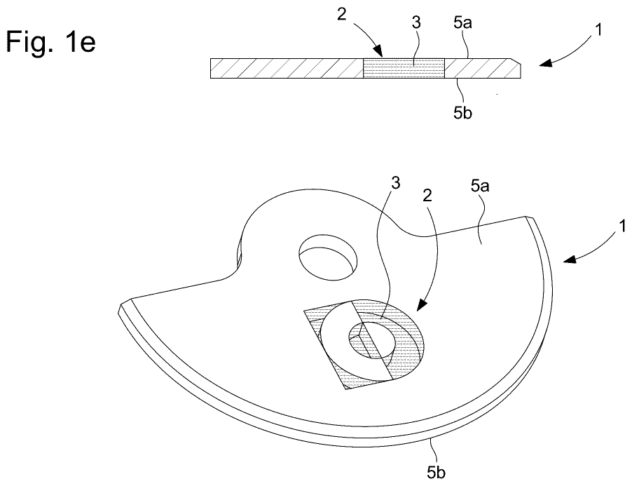

The method is illustrated in FIGS. 1a to 1e in 5 steps from a) to e) for an oscillating weight. In a first step a), the item without any decoration, which will be referred to as a blank 5 or substrate, is obtained. The blank 5 is defined with an upper face 5a and with a lower face 5b opposite the upper face 5a. The upper face can be either the face intended to face the observer when in use or the opposite face. In a second step b), a non-through decoration 2a is produced from the upper face 5a. The non-through decoration can, for example, be produced by laser ablation. Optionally, this step b) can be omitted if a blank provided with the non-through decoration 2a is directly obtained in step a), this blank being produced by injection moulding for example. In a third step c), the enamel 3 is deposited within the non-through decoration 2a. Ideally, the deposit is carried out by liquid spraying with a view to industrial production. Alternatively, it can be deposited quickly by hand using a brush or by sprinkling a powder. The blank 5 is then fired to vitrify the deposited enamel. Preferably, a plurality of layers of enamel are deposited with, after each deposition step, a firing cycle to ensure that the enamel is bubble-free. Enamel layers of different colours can be deposited and/or the colour of the enamel deposited for each layer can be varied. The number of layers of enamel deposited is typically between 2 and 15, preferably between 3 and 10, for a total thickness greater than or equal to 0.5 mm, preferably greater than or equal to 0.8 mm. The maximum total thickness can be as much as 1.5 mm, with the maximum thickness being limited only by production times. A fourth machining step d) is then carried out, preferably by grinding, on the lower face 5b of the blank 5 to reveal the enamel 3, thus obtaining the through-decoration 2. Then, preferably, a final polishing operation is carried out to make the ground surface perfectly shiny and guarantee good transparency of the enamel. Optionally, in step e), the upper face 5a can also be machined by grinding to obtain an enamel decoration perfectly flush with the substrate. Again, this machining can be completed by polishing. In the case of a flat part, grinding and polishing of the top and bottom can be carried out in a single operation using satellite lapidary machines. According to the invention, the upper and/or lower face can be machined in an inclined plane to obtain a translucent-opaque graduation if the enamel layer has an opaque appearance before machining. It should be noted that the opaque, transparent or translucent appearance will be dictated by the greater or lesser presence of pigments within the enamel and by the thickness of the layer.

Optionally, one or both faces can be subjected to finishing treatments such as satin-finishing or laser texturing.

1. A method for manufacturing an item (1) comprising a through-decoration (2) filled with an enamel (3) to form a plique-à-jour enamel, the method comprising the steps of:
obtaining a blank (5) defined with an upper face (5a) and a lower face (5b) opposite the upper face (5a);
removing part of the blank (5) from the upper face (5a) to produce a decoration (2a) that does not pass through to the lower face (5b) or, alternatively, in the previous step, obtaining said blank (5) directly with the non-through decoration (2a);
depositing one or more layers of enamel (3) within the non-through decoration (2a) and firing the enamel (3) after each layer has been deposited; and
machining, preferably by grinding, the lower face (5b) to reveal the enamel (3) and thus produce the item (1) with the through-decoration (2) filled with enamel (3).

2. The method according to claim 1, comprising a further machining step, preferably by grinding the enamel (3) of the upper face (5a) to obtain an enamel decoration flush with the upper face (5a), which further step can be concurrent with the step of machining the lower face (5b).

3. The method according to claim 2, comprising a step of polishing the upper face (5a) and/or the lower face (5b) after the machining step and/or the further machining step.

4. The method according to claim 1, wherein said blank (5) is made of a material with a melting point greater than or equal to 650° C.

5. The method according to claim 1, wherein the deposition of one or more layers of enamel (3) is carried out by liquid spraying, using a brush or by sprinkling a powder.

6. The method according to claim 1, wherein the number of layers of enamel (3) deposited is between 2 and 15, preferably between 3 and 10.

7. The method according to claim 1, wherein during the step of depositing one or more layers of enamel (3), layers of enamel (3) of different colours are deposited and/or the colour within the same layer is modulated.

8. The method according to claim 2, wherein the enamel (3) is machined during the machining step and/or during the further machining step according to an inclined plane to produce a gradation of more or less transparent areas.

9. An item (1) comprising an upper face (5a) and a lower face (5b) opposite the upper face (5a), the item (1) comprising a through-decoration (2) made of plique-à-jour enamel with an enamel thickness greater than or equal to 0.5 mm, preferably greater than or equal to 0.8 mm.

10. The item (1) according to claim 9, said item (1) being an external timepiece component or component of the movement.

11. The item (1) according to claim 9, said item (1) being an external timepiece component.

12. The item (1) according to claim 9, said item (1) being made of a ceramic, a sapphire or a cermet.

13. The item (1) according to claim 12, said item (1) being made of zirconium oxide.
